(19) United States
(12) Patent Application Publication
(10) Pub. No.: US 2011/0106877 A1
(43) Pub. Date: May 5, 2011

(54) SYSTEM AND METHOD FOR TRANSFERRING FILES BY EXCLUSIVE-LINE CONNECTION

(75) Inventors: Ching-Feng Hsieh, Taipei (TW); WenJun Jiang, Qianjiang City (CN)

(73) Assignee: ASKEY COMPUTER CORPORATION, Taipei (TW)

(21) Appl. No.: 12/750,409

(22) Filed: Mar. 30, 2010

(30) Foreign Application Priority Data
Oct. 30, 2009 (TW) 098136833

(51) Int. Cl. G06F 15/16; G06F 17/30

(52) U.S. Cl. 709/203; 707/770; 707/E17.014; 707/E17.01

(57) ABSTRACT

A system and method for file transfer via an exclusive line is for use with at least two local area networks (LANs) connected via an exclusive line and each having at least a client and a server. The method includes: when a client sends an upload instruction, storing upload files in the server in the same LAN as the client;

when a client sends a download instruction, searching the server in one of the LANs for download files specified by the download instruction, if it is not found, searching the server of the other LAN via the exclusive line and further shadow copying the found download files to the server of the other LAN via the exclusive line to allow the client of the same LAN to download, thereby providing proximate end downloading services and solving the conventional drawbacks of exclusive-line overloading, network congestion, low transmission speed and high cost.

### BACKGROUND OF THE INVENTION

1. Field of the Invention

The present invention relates generally to file transfer techniques, and more particularly, to a system and method for transferring files between different local area networks (LANs) connected via an exclusive line.

2. Description of Related Art

The Internet and local area networks (LANs) have become increasingly important tools of office automation, and online file transfer is clearly a basic need for users. Transferring files over a network means transferring files between computers over the Internet or LANs according to certain rules, for example, transferring files between clients, servers, or between clients and servers, thereby achieving the sharing of resources.

Currently, many enterprises, especially syndicates, set up branch offices around the world. In order to accomplish file transfer or resources sharing between headquarters and branch offices or between branch offices, LANs are established in the branch offices and generally connected via an exclusive lines so as to transmit large-volume files with high security and high speed, thereby implementing enterprise resource planning (ERP), office automation (OA), files interconnection, or ERP/OA file copying. Advantageous features of exclusive-line connection are, namely quick transfer, stable online transfer, and encryption of files transmitted. However, exclusive-line connection still has its own drawbacks.

FIG. 1 is a schematic view of a conventional file transfer architecture with different local area networks (LANs) connected via an exclusive line. Referring to FIG. 1, when client A in a first LAN 11 sends files to clients B, C, D in a second LAN 12, the files must be sent to a server 111 in the first LAN 111 first so as for clients B, C, D to download the files from the server 111 through an exclusive line 13. On the other hand, when clients B, C, D need to return the files to client A, the files to be returned to client A must be sent to the server 111 via the exclusive line 13. Transferring the same files multiple times between the LANs via the exclusive line 13 overloads the exclusive line 13. Further, insufficient bandwidth or network congestion may occur due to a plethora of clients or files over the networks. Furthermore, the above-described network architecture incurs high network communication costs due to high-volume traffic flows between the LANs.

Therefore, it is imperative to provide a file transfer technique so as to overcome the above-described drawbacks of the prior art.

### SUMMARY OF THE INVENTION

According to the above drawbacks, the present invention provides a system and method for transferring files by exclusive-line connection so as to overcome the conventional drawbacks of exclusive-line overloading, slow file transfer, and network congestion between different local area networks (LANs).

In order to achieve the above and other objects, the present invention discloses a system and method for transferring files by exclusive-line connection, which are applicable to an architecture comprising at least two local area networks (LANs), wherein the LANs are connected to each other via an exclusive line and have at least a client and at least a server responsive to instructions from the at least a client. The system comprises: file transfer processing modules built in the servers of the LANs, respectively, for receiving upload and download instructions from the at least a client located in the same LANs as the servers; storage modules built in the servers, respectively, such that when the server in one of the LANs receives an upload instruction from the at least a client in the same LAN, the storage module of the server stores upload files specified by the upload instruction and sends a first shadow copy instruction to the other LAN via the exclusive line; search modules built in the servers, respectively, such that when the server in one of the LANs receives a download instruction from the at least a client in the same LAN, the search module of the server searches the storage module of the server for download files specified by the download instruction, if the download files is found, it is provided to the client for download, otherwise, if the download files is not found, the search module further searches the server in the other LAN via the exclusive line for the download files, and sends a second shadow copy instruction to the other LAN; and shadow copy modules built in the servers, respectively, such that when the server in one of the LANs receives the first shadow copy instruction from the server in the other LAN, the shadow copy module of the server in the one of the LANs stores the upload files specified by the first shadow copy instruction, and when the server in the one of the LANs receives the second shadow copy instruction from the server of the other LAN via the exclusive line, the shadow copy module of the server in the one of the LANs stores the download files specified by the second shadow copy instruction.

The method for transferring files by exclusive-line connection comprises the steps of: storing, upon the server's receipt of an upload instruction from the at least a client in the same LAN as the server, by the server an upload file specified by the upload instruction and sending a shadow copy instruction to the other LAN via the exclusive line; and storing, after the server in the other LAN receives the shadow copy instruction via the exclusive line, on the server in the other LAN the upload files specified by the shadow copy instruction so as for the client in the same LAN to download the upload files.

According to another embodiment, the method comprises the steps of: searching, after the server in one of the LANs receives a download instruction from the client in the same LAN as the server, the server for download files specified by the download instruction, providing the download files found to the client, and searching the server in the other LAN via the exclusive line for the download files and sending another shadow copy instruction to the other LAN if the download files are not found; and storing, after the server in the other LAN receives said another shadow copy instruction via the exclusive line, the download files specified by said another shadow copy instruction in the server in the other LAN so as for the client in the same LAN as the server to download the download files.

Therefore, the present invention provides proximate end downloading services so as to efficiently overcome the conventional drawbacks of exclusive-line overloading, slow file transfer, network congestion, and high network communication costs.

### BRIEF DESCRIPTION OF DRAWINGS

FIG. 1 is a schematic view of a conventional file transfer architecture with different local area networks (LANs) connected via an exclusive line;

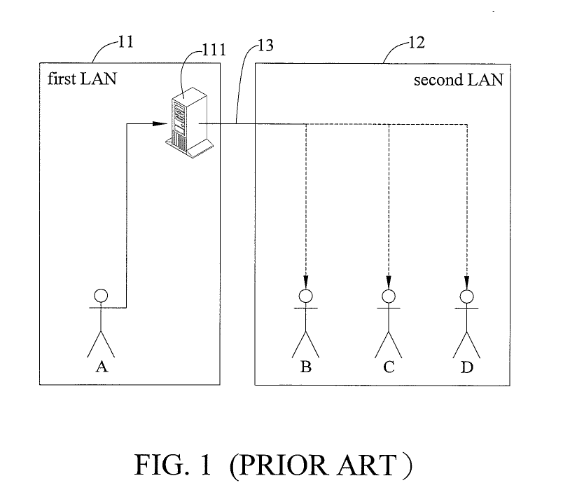

FIG. 2 is a block diagram showing the basic structure of a system for transferring files by exclusive-line connection according to the present invention;

FIG. 3 is a flow diagram showing a method for transferring files by exclusive-line connection according to the present invention; and

FIG. 4 is a schematic view of a system and method for transferring files by exclusive-line connection according to an embodiment of the present invention.

### DETAILED DESCRIPTION OF PREFERRED EMBODIMENTS

The following illustrative embodiments are provided to illustrate the disclosure of the present invention, these and other advantages and effects are apparent to those skilled in the art after reading the specification. It should be noted that the diagrams are intended for illustrative purposes but are not intended to limit the present invention.

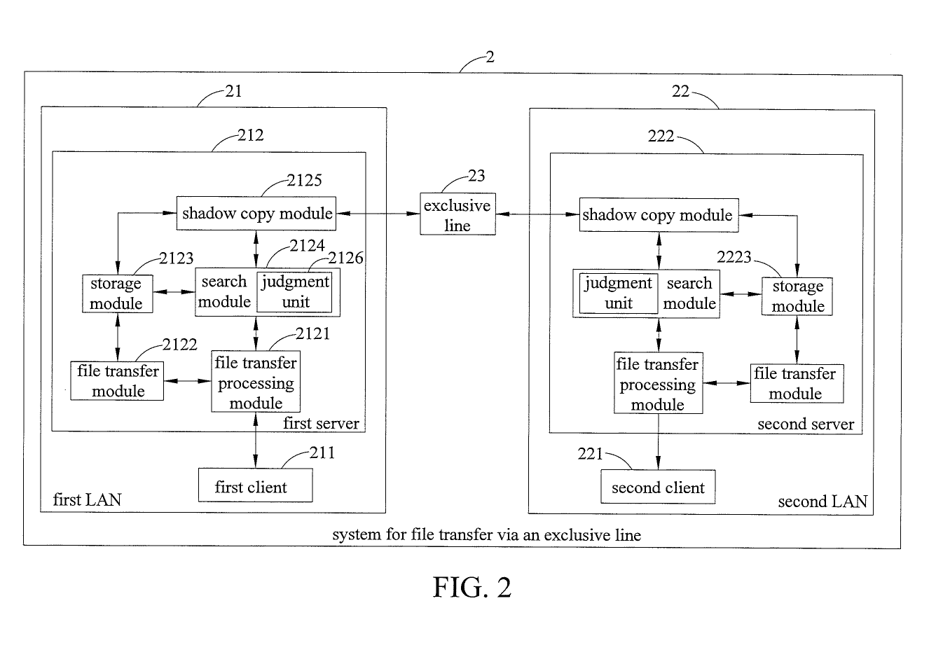

Referring to FIG. 2, there is shown a block diagram of the basic structure of a system 2 for transferring files by exclusive-line connection according to the present invention. As shown in the drawing, the system 2, which is applicable to an architecture, comprises a first local area network (hereinafter referred to as “first LAN”) 21 and a second local area network (hereinafter referred to as “second LAN”) 22. The system 2 further comprises: a first client 211 and a first server 212 located in the first LAN 21; a second client 221 and a second server 222 located in the second LAN 22; and an exclusive line 23.

In the present embodiment, the first and second LANs 21, 22 are attributed to and dedicated to branch offices of a syndicate. The exclusive line 23 is an exclusive line connecting the LANs of the branch offices. The first and second clients 211, 221 are user computers. The first and second servers 212, 222 are LAN servers. In the present embodiment, each of the first and second LANs 21, 22 has, but is not limited to, one client and one server. In the practical network architectures, the first and second LANs 21, 22 have a plurality of clients and servers, respectively.

The first client 211 is located in the first LAN 21 and has a built-in file transfer processing program for transferring upload and download instructions. The second client 221 is located in the second LAN 22 and has a built-in file transfer processing program for transferring upload and download instructions. In the present embodiment, the file transfer processing programs are file transfer protocol (FTP) programs for controlling two-way transfer of files over the networks. The file transfer processing programs are application programs through which the clients are connected to the servers running FTP programs so as to access files of the servers.

The first server 212 is located in the first LAN 21 and connected to the first client 211 for responding to upload and download instructions sent from the first client 211 and performing corresponding processing. The second server 222 is located in the second LAN 22 and connected to the second client 221 for responding to upload and download instructions sent from the second client 221 and performing corresponding processing. In the present embodiment, as shown in FIG. 2, the first server 212 comprises a file transfer processing module 2121, a files compression module 2122, a storage module 2123, a search module 2124, a shadow copy module 2125 and an judgment unit 2126, and the second server 222 also has the same components as those of the first server 212.

Since the first and second servers 212, 222 of the file transfer system have the same components and the same working principles, only the first server 212 is described in detail for the purpose of brevity.

The file transfer processing module 2121 is connected to the first client 211 so as to send a files compression instruction when receiving an upload instruction from the first client 211 and send a search instruction when receiving a download instruction from the first client 211. In the present embodiment, the file transfer processing module 2121 is an application program such as a FTP program, through which the first client 211 is connected to the first server 212 to access files of the first server 212.

The files compression module 2122 is connected to the file transfer processing module 2121 so as to compress and convert upload files from the file transfer processing module 2121 into a compressed file when receiving the files compression instruction from the file transfer processing module 2121, and send a storage instruction. In the present embodiment, the compressed file is a zip file.

The storage module 2123 is connected to the files compression module 2122 so as to store the compressed file when receiving the storage instruction from the files compression module 2122, and send a shadow copy instruction. In the present embodiment, the storage module 2123 is a file database, and compressed files in the file database are classified and stored according to filename, type, time and date of file saved and so on. Further, It should be noted that the purpose of the above-described compression is to reduce storage space required by the upload files. In another embodiment, the upload files are selectively not compressed. As such, the file transfer processing module 2121 can be directly connected to the storage module 2123.

The search module 2124 is connected to the file transfer processing module 2121 and the storage module 2123 so as to search the server in one of the LANs for download files requested by the download instruction from the first client 211 when receiving the search instruction from the file transfer processing module 2121. In particular, the search module 2124 searches for the download files requested by the download instruction of the first client 211 in the storage module 2123 of the server in one of the LANs according to such information as filename, type or time and date of file saved, if the download files is found, a download process is performed, otherwise, the search module 2124 searches for the download file in the server of the other LAN via the exclusive line 23 and sends a shadow copy instruction. In other words, if the storage module 2123 of the first server 212 in the first LAN 21 does not have the download files requested by the download instruction from the first client 211, the storage module 2223 of the second server 222 in the second LAN 22 is searched for the download files, and when the download files is found, a shadow copy instruction is sent out.

In the present embodiment, the search module 2124 further comprises a judgment unit 2126. If the storage module 2123 of the first server 212 in the first LAN 21 does not have the download files requested by the download instruction from the first client 211, the judgment unit 2126 judges whether another client of the first LAN 21 (not shown in FIG. 2) sends the same download instruction, if yes, the download progress of said another client is detected so as to acquire the requested download files from the storage module 2123 after the download process is completed, otherwise, the shadow copy instruction is sent out.

The shadow copy module 2125 is connected to the search module 2124 and the exclusive line 23. When the shadow copy module 2125 receives the shadow copy instruction from the search module 2124, it shadow-copies the compressed file stored in the storage module 2123 to the servers of different LANs via the exclusive line 23 so as for the clients in the same LANs to download the compressed file. In other words, when the shadow copy module 2125 of the first server 212 in the first LAN 21 receives the shadow copy instruction from the search module 2124, it shadow-copies the compressed file stored in the storage module 2123 to the second serve 222 in the second LAN 22 via the exclusive line 23 so as for the second client 221 in the second LAN 22 to download the compressed file. In particular, the compressed file of the storage module 2123 of the first server 212 is shadow-copied to the storage module 2223 of the second server 222 in the second LAN 22 via the exclusive line 23 so as for the second client 221 in the second LAN 22 to download the compressed file. That is, shadow copy achieves the sharing of files between the servers of different LANs. The shadow copy modules of the servers in different LANs are configured to set position and size for shadow copy storage. In the present embodiment, the position for shadow copy storage refers to the server in another LAN, and the size refers to the maximum size for shadow copy storage.

Further, the shadow copy module 2125 is connected to the storage module 2123 and the exclusive line 23. When the shadow copy module 2125 receives the shadow copy instruction from the storage module 2123, it shadow-copies the compressed file stored in the storage module 2123 to the servers of other LANs via the exclusive line 23 so as for the clients in the other LANs to download the compressed file. In other words, when the shadow copy module 2125 of the first server 212 in the first LAN 21 receives the shadow copy instruction from the storage module 2123, it shadow-copies the compressed file stored in the storage module 2123 to the second server 222 in the second LAN 22 via the exclusive line 23. In particular, the compressed file of the storage module 2123 of the first server 212 is shadow-copied to the storage module 2223 of the second server 222 of the second LAN 22 so as for the second client 221 of the second LAN 22 to download the compressed file.

Since the second client 221 in the second LAN 22 uploads and downloads files in the same way as the above-described principles, detailed description thereof is omitted herein.

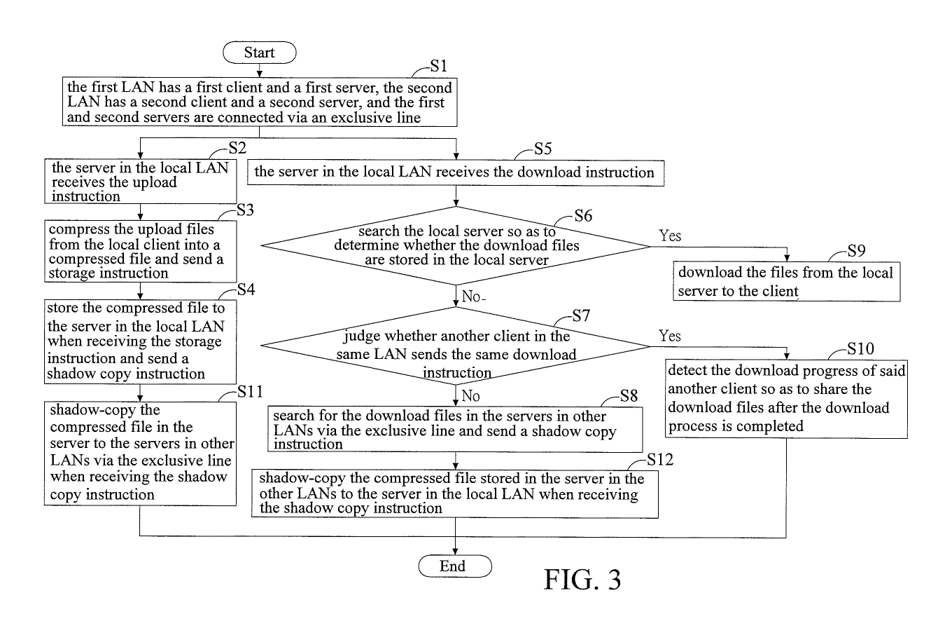

The present invention further provides a method for transferring files by exclusive-line connection. As shown in FIG. 3, the method for transferring files by exclusive-line connection comprises the following steps.

First, in step S1, a first LAN and a second LAN are built up and connected with each other. In particular, the first LAN has a first client and a first server, and the second LAN has a second client and a second server, and the first and the second servers are connected via an exclusive line. More particularly, the first LAN comprises at least a first client that has a file transfer processing program for sending upload and download instructions, and at least a first server for responding to the upload and download instructions from the first client and performing corresponding processing; the second LAN comprises at least a second client that has a file transfer processing program for sending upload and download instructions, and at least a second server for responding to the upload and download instructions from the second client and performing corresponding processing. In the present embodiment, the file transfer processing programs are application programs, through which the clients are connected to the servers in one of the LANs for accessing programs and information of the servers. The first and second LANs are attributed to and dedicated to different branch offices of a syndicate. The exclusive line is an exclusive network for connecting the LANs of the branch offices. The first client and the second client are staff computers of different branch offices. The first and second servers are LAN servers. Then, the process goes to step S2 or step S5. It should be noted that steps S2-S4 shows processes for the first client or the second client to upload files, and steps S5-S12 show processes for the first client or the second client to download files. In step S2, an upload instruction sent from the first client or second client located in different LANs is received by the server in one of the LANs. Then, the process goes to step S3.

In step S3, the server compresses the upload files of the first client or the second client into a compressed file and sends a storage instruction. In the present embodiment, the compressed file is a zip file. The purpose of compression is to reduce storage space required by the upload files. In another embodiment, the upload files are selectively not compressed. Then, the process goes to step S4.

In step S4, when the server in the one of the LANs receives the storage instruction, it stores the compressed file and sends a shadow copy instruction (first shadow copy instruction), wherein the shadow copy instruction comprises shadow copy specified LAN information, through which the compressed file is automatically shared between the servers in other LANs (step S11) so as for the clients of the other LANs to download the compressed file, thereby providing proximate end downloading services so as to prevent high-volume traffic flows that may otherwise occur when the clients of different LANs download files via the exclusive line. In the present embodiment, the compressed file is stored in the server in the one of the LANs (in the same LAN), and in particular, is stored in the file database of the server. Compressed files of the file database are classified and stored according to filename, type, or time and date of file saved and so on. Then, the process goes to step S11.

Steps S5-S12 show processes of a server that are performed when the server receives a download instruction from a client in the same LAN. In step S5, the first server in the first LAN receives a download instruction sent from the first client located in the first LAN or the second client located in the second LAN. Then, the process goes to step S6.

In step S6, the server in the local LAN searches the local LAN for download files specified by the download instruction, if the download files is found, the process goes to step S9, wherein the server in the local LAN provides the download files to the client which has sent the download instruction, otherwise, the process goes to step S7 if no download file is found.

In step S7, the server in the local LAN judges whether another client in the same LAN also sends a download instruction specifying the same download files, i.e., the same download instruction, if so, the process goes to step S10, wherein the server detects the download progress of said another client such that after the download process is completed, the server can acquire the download files and send it to the client which has sent the download instruction and the whole process is over; otherwise, if no client sends the same download instruction, the process goes to step S8. In the above-described steps S9 and S10, the files stored in the local LAN or files being downloaded in the local LAN is provided to the client such that the client does not need to send download requests to other LANs via the exclusive line, thereby reducing the traffic flow on the exclusive line.

In step S8, the server in the local LAN searches for the download files in the servers of other LANs via the exclusive line and sends a shadow copy instruction (the second shadow copy instruction) to the server providing the download files, then the process goes to step S12.

In step S11, when a server receives the shadow copy instruction from the same LAN, the server shadow-copies the compressed file stored therein to the servers in other LANs via the exclusive line, and the whole process is over. The shadow copy instruction refers to the first shadow copy instruction corresponding to the upload instruction.

In step S12, according to the shadow duplication instruction, the compressed file stored in the server in the other LAN is shadow-copied to the server in the local LAN via the exclusive line, and the whole process is over. The shadow copy instruction refers to the second shadow copy instruction corresponding to the download instruction.

In steps S11 and S12, since the shadow copy instructions comprises shadow copy specified LAN information, the upload files or download files (whether compressed or selectively not compressed) are automatically stored in the servers of different LANs so as for clients in the same LANs to download, thereby providing proximate end downloading services and preventing high traffic flow on the exclusive line.

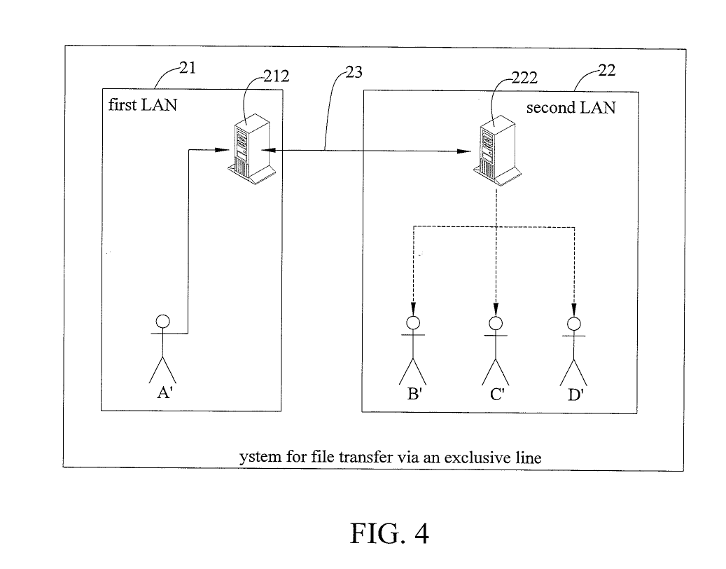

FIG. 4 is a schematic view of a system and method for transferring files by exclusive-line connection according to an embodiment of the present invention. As shown in the drawing, when a client A′ in a first LAN 21 needs to transfer files to clients B′, C′ and D′ in a second LAN 22, the files is first uploaded to a first server 212 in the first LAN 21 and optionally compressed by the first server 212, and then rendered accessible by the second server 222 in the second LAN 22 through shadow copy. Thus, the clients B′, C′ and D′ in the second LAN 22 can download the files from the second server 222 in the second LAN 22. Therefore, the files is transferred only once on the exclusive line. On the other hand, when the client B′ in the second LAN 22 sends a download instruction for files download and the second server 222 in the second LAN 22 fails to find the requested files in the second LAN 22, the second server 222 searches the first server 212 in the first LAN 21 via the exclusive line and shadow-copies the requested files to the second server 222. Thus, if the client C′ or D′ in the second LAN 22 also needs the files, it only needs to download the files from the second server 222 in the second LAN 22. Therefore, the present invention solves the conventional drawbacks of exclusive-line overloading, network congestion, low transmission speed and high network communication cost.

The above-described descriptions of the detailed embodiments are only to illustrate the preferred implementation according to the present invention, and it is not to limit the scope of the present invention, Accordingly, all modifications and variations completed by those with ordinary skill in the art should fall within the scope of present invention defined by the appended claims.

What is claimed is:

1. A system for transferring files by exclusive-line connection, applicable to an architecture comprising at least two local area networks (LANs), wherein the LANs are connected to each other via an exclusive line and each have at least a client and at least a server responsive to instructions from the at least a client, the system comprising:
file transfer processing modules built in the servers of the LANs, respectively, for receiving upload and download instructions from the at least a client located in the same LANs as the servers;
storage modules built in the servers, respectively, such that when the server in one of the LANs receives an upload instruction from the at least a client in the same LAN as the server, the storage module of the server stores upload files specified by the upload instruction and sends a first shadow copy instruction to the other LAN via the exclusive line;
search modules built in the servers, respectively, such that when the server in one of the LANs receives a download instruction from the at least a client in the same LAN as the server, the search module of the server searches the storage module of the server for download files specified by the download instruction, provides the download files found to the client having sent the download instruction, and searches, if the download files are not found, the server in the other LAN via the exclusive line for the download files, and sends a second shadow copy instruction to the other LAN; and
shadow copy modules built in the servers, respectively, such that when the server in one of the LANs receives the first shadow copy instruction from the server in the other LAN, the shadow copy module of the server in the one of the LANs stores the upload files specified by the first shadow copy instruction, and when the server in the one of the LANs receives the second shadow copy instruction from the server of the other LAN via the exclusive line, the shadow copy module of the server in the one of the LANs stores the download files specified by the second shadow copy instruction.

2. The system of claim 1, wherein the search module further comprises a judgment unit such that when the search module fails to find the download files in the storage module of the server in the one of the LANs, the judgment unit judges whether a download instruction specifying the download files has been sent by another client in the same LAN as the server, if yes, the judgment unit detects the download progress, otherwise, if no download instruction specifying the download files is sent by the another client in the same LAN as the server, the second shadow copy instruction is sent to the other LAN via the exclusive line.

3. The system of claim 1, further comprising files compression modules built in the servers, respectively, for compressing the upload files to be then stored by the storage modules before the upload files are stored by the storage modules of the servers in the one of the LANs.

4. The system of claim 1, wherein the shadow copy module of the server for receiving the first shadow copy instruction is configured to set position and size for shadow copy storage, wherein the position refers to the storage module of the server in the one of the LANs that receives the first shadow copy instruction and the size refers to maximum size of the storage module allocated for storing the upload files specified by the first shadow copy instruction.

5. The system of claim 1, wherein the shadow copy module of the server for receiving the second shadow copy instruction is configured to set position and size for shadow copy storage, wherein the position refers to the storage module of the server for receiving the second shadow copy instruction and the size refers to maximum size of the storage module allocated for storing the download files specified by the second shadow copy instruction.

6. The system of claim 1, wherein file transfer processing programs are built in the clients of different LANs, respectively, so as to transmit and process upload and download instructions with the file transfer processing modules of the servers in the one of the LANs.

7. The system of claim 1, wherein the file transfer processing programs and the file transfer processing modules are FTP programs.

8. A method for transferring files by exclusive-line connection, applicable to an architecture comprising at least two local area networks (LANs), wherein the LANs are connected to each other via an exclusive line and have at least a client and at least a server responsive to instructions from the at least a client, the method comprising the steps of:
storing, upon the server's receipt of an upload instruction from the at least a client in the same LAN as the server, by the server an upload file specified by the upload instruction and sending a shadow copy instruction to the other LAN via the exclusive line; and
storing, after the server in the other LAN receives the shadow copy instruction via the exclusive line, on the server in the other LAN the upload files specified by the shadow copy instruction so as for the client in the same LAN to download the upload files.

9. The method of claim 8, wherein the upload files specified by the upload instruction is compressed before being stored in the server that receives the upload instruction.

10. The method of claim 8, further comprising the steps of:
searching, after the server that receives the upload instruction receives a download instruction from the client in the same LAN as said local server, the server that receives the upload instruction for download files specified by the download instruction, providing the download files found to the client, and searching the server in the other LAN via the exclusive line for the download files and sending another shadow copy instruction to the other LAN if the download files are not found; and
storing, after the server in the other LAN receives said another shadow copy instruction via the exclusive line, the download files specified by said another shadow copy instruction in the server in the other LAN so as for the client in the same LAN as the server to download the download files.

11. The method of claim 10, wherein the download files specified by said another shadow copy instruction is compressed before being stored in said server in the other LAN.

12. The method of claim 10, further comprising the steps of judging whether a download instruction specifying the download files has been sent by another client in the same LAN, detecting download progress if so, and sending said another shadow copy instruction to the other LAN via the exclusive line if not, when the server that receives the upload instruction fails to find the download files specified by the download instruction in the LAN having the server that receives the upload instruction.

13. A method for file transfer via an exclusive line, applicable to an architecture comprising at least two local area networks (LANs), wherein the LANs are connected to each other via the exclusive line and each have at least a client and at least a server responsive to instructions from the at least a client, the method comprising the steps of:
searching, after the server in one of the LANs receives a download instruction from the client in the same LAN as the server, the server for download files specified by the download instruction, providing the download files found to the client, and searching the server in the other LAN via the exclusive line for the download files and sending a shadow copy instruction to the other LAN if the download files is not found; and
storing, after the server in the other LAN receives the shadow copy instruction via the exclusive line, the download files specified by the shadow copy instruction in said server in the other LAN so as for the client in the same LAN as the server to download the download files.

14. The method of claim 13, wherein the download files specified by the shadow copy instruction is compressed before being stored in the server in the other LAN.

15. The method of claim 13, further comprising the steps of judging whether a download instruction specifying the download files has been sent by another client in the same LAN, detecting download progress if so, sending said shadow copy instruction to the other LAN via the exclusive line if not, when the server in the one of the LANs fails to find the download files in the one of the LANs during the searching step.

16. The method of claim 13, further comprising the steps of:
storing, after the server in the one of the LANs receives an upload instruction from the client in the same LAN as the local server, upload files specified by the upload instruction in the server in the one of the LANs and sending another shadow copy instruction to the other LAN via the exclusive line; and
storing, after the server in the other LAN receives said another shadow copy instruction via the exclusive line, the upload files specified by said another shadow copy instruction in the server in the other LAN so as for the client in the other LAN to download the upload files.

17. The method of claim 16, wherein the upload files specified by the upload instruction is compressed before being stored in the server in the one of the LANs.
